(19) United States
(12) Patent Application Publication
(10) Pub. No.: US 2011/0141912 A1
(43) Pub. Date: Jun. 16, 2011

(54) FIELD CORRECTIVE ACTION BASED ON PART LIFE DURATIONS

(75) Inventors: Michael Soures, Webster, NY (US); Robert Pozniakas, Rochester, NY (US)

(73) Assignee: XEROX CORPORATION, NORWALK, CT (US)

(21) Appl. No.: 12/634,790

(22) Filed: Dec. 10, 2009

(51) Int. Cl. H04L 12/26

(52) U.S. Cl. 370/242

(57) ABSTRACT

A method and system determine if a failed part failed prematurely by evaluating whether the failed part failed within one of a plurality of predetermined threshold usage ranges. The predetermined threshold ranges are less than a predicted full useful life of the failed part. Therefore, if the part failed within one of the usage ranges it would be considered to have failed before its predicted full useful life and to have failed prematurely. If the failed part failed prematurely, the method cross-references a service recommendation table to identify a service recommendation based on which of the predetermined threshold usage ranges the failed part failed within. The service recommendation table provides different service recommendations for different predetermined threshold usage ranges of different parts. The service recommendations are often recommendations that adjust or replace items other than the failed part itself. Thus, the service recommendations address the root cause that may have caused the part to fail prematurely.

### BACKGROUND AND SUMMARY

Embodiments herein generally relate to systems and devices that can self-diagnose defects and provide service recommendations, and more particularly to systems and devices that provide different service recommendations for different predetermined threshold usage ranges of different parts that wear out prematurely.

Various systems track the average lifespan of parts used in individual machines, such as high frequency service items (HFSI). Such devices can include customer replaceable units (CRU's). However, in some machines certain parts are replaced more frequently than would be expected, and the parts never reach their predicted full useful life. This is often caused because a failed part that consistently wears out prematurely does so because of a root cause not associated with the failed part itself. For example, an improperly adjusted alignment mechanism could cause a belt to consistently wear out prematurely. Conventional systems may only instruct the service engineer to replace the belt, without fixing the root cause (the improperly adjusted alignment mechanism). The embodiments described herein provide additional information to the service engineer that allows the service engineer to correct the root cause, instead of just replacing the failed part.

Many operating devices can self-diagnose failed operating conditions. This self-diagnosis can range from a simple sensor that determines that a supply container within the device is empty, to a complex processor that evaluates whether the quality of the device is within an acceptable range. One exemplary method herein receives from such an apparatus or device, an identification of a failed part within the apparatus. For example, a printing apparatus, such as a printer or copier could self-diagnose that it has a failed or worn out drum or belt. This identification can be received by the device itself (e.g., by the printer or copier) or by a computing device (such as a special purpose or general purpose computer) that is in communication with the self-diagnosing apparatus.

The method determines (using the computing device) if the failed part failed prematurely by evaluating whether the failed part failed within one of a plurality of predetermined threshold usage ranges. The predetermined threshold ranges are less than a predicted full useful life of the failed part. Therefore, if the part failed within one of the usage ranges it would be considered to have failed before its predicted full useful life and to have failed prematurely.

If the failed part failed prematurely, the method cross-references a service recommendation table to identify a service recommendation based on which of the predetermined threshold usage ranges the failed part failed within (using the computing device). The service recommendation table provides different service recommendations for different predetermined threshold usage ranges of different parts. The service recommendations are often recommendations that adjust or replace items other than the failed part itself.

Thus, the service recommendations address the root cause that may have caused the part to fail prematurely. Further, the threshold ranges are different for different parts of the apparatus because different root causes are identified by unique usage ranges. In other words, failure within a first usage range would indicate that one set of circumstances could be the root cause of the premature failure of the part; while failure within a second usage range would indicate that a different set of circumstances could be the root cause of the premature failure of the part. Each of these different usage ranges is unique to each different root cause.

To determine whether the failed part failed prematurely, the embodiments herein use the computing device to extract usage data from a usage meter within the apparatus and/or the failed part, and to compare the usage data to the predetermined threshold usage ranges to identify which of the predetermined threshold usage ranges the failed part failed within.

The method outputs, from the computing device, instructions to service the failed part and the service recommendations to a service engineer. This not only tells the service engineer which part needs to be replaced, but also provides the service engineer with an instruction to replace or adjust a different part or element that was the root cause of the premature failure of the part.

The embodiments herein can maintain and constantly update the service recommendation table based on historical and new incoming service records of apparatuses similar to the apparatus. In other words, as new root causes are discovered over time, the service recommendation table can be continually updated.

Also disclosed herein are device embodiments that include an input/output device operatively connected to a processor. The input/output device receives, from a second apparatus (separate from the apparatus) an identification of the failed part within the second apparatus.

A computer-readable storage medium is also operatively connected to the processor. The computer-readable storage medium stores programming instructions executable by the processor, stores the plurality of predetermined threshold usage ranges, and stores the service recommendation table.

The processor determines if the failed part failed prematurely by evaluating whether the failed part failed within one of the plurality of predetermined threshold usage ranges. The processor determines whether the failed part failed prematurely by extracting usage data from a usage meter within the second apparatus and/or the failed part, and comparing the usage data to the predetermined threshold usage ranges to identify which of the predetermined threshold usage ranges the failed part failed within. The processor also maintains the service recommendation table based on historical and new service records of second apparatuses similar to the second apparatus.

If the failed part failed prematurely, the processor cross-references the service recommendation table to identify the service recommendation based on which of the predetermined threshold usage ranges the failed part failed within. Then, the input/output device outputs instructions to service the failed part and the service recommendation.

Understanding where within the overall life distribution the parts are failing provides better identification of the root cause of the failure and provides the most appropriate diagnostic and repair information to the customer or the customer service engineer (CSE).

These and other features are described in, or are apparent from, the following detailed description.

### BRIEF DESCRIPTION OF THE DRAWINGS

Various exemplary embodiments of the systems and methods are described in detail below, with reference to the attached drawing figures, in which:

FIG. 1 is a flowchart illustrating embodiments herein;

FIG. 2 is a table according to embodiments herein;

FIG. 3 is a table according to embodiments herein;

FIG. 4 is a table according to embodiments herein;

FIG. 5 is a table according to embodiments herein; and

FIG. 6 is a schematic diagram of a device according to embodiments herein.

### DETAILED DESCRIPTION

As mentioned above, in some machines certain parts are replaced more frequently than would be expected, and the parts never reach their predicted full useful life. This is often caused because a failed part that consistently wears out prematurely does so because of a root cause not associated with the failed part itself. Conventional systems may only instruct the service engineer to replace the failed part, without fixing the root cause. The embodiments described herein provide additional information to the service engineer that allows the service engineer to correct the root cause, instead of just replacing the failed part.

The embodiments herein comprise methods and systems that provide a service representative with possible failure mode information when a part is replaced early. Based on failure mode effect analysis (FMEA) a parts life profile can be generated. During testing (and after launch) root causes for early part replacements can be identified. These root causes are used to drive a rules-based system that detects whether parts replacements are being made earlier than expected (based on the FMEA full useful life projections). If a part fails before it's full useful life has expired, the embodiments herein notify the service engineer of potential problems that could cause failures at that point in the ‘parts life curve’. Thus, one of the concepts presented herein is the generation of customized service ‘hints’ based on fleet data profiles relative to individual machine parts replacement actions.

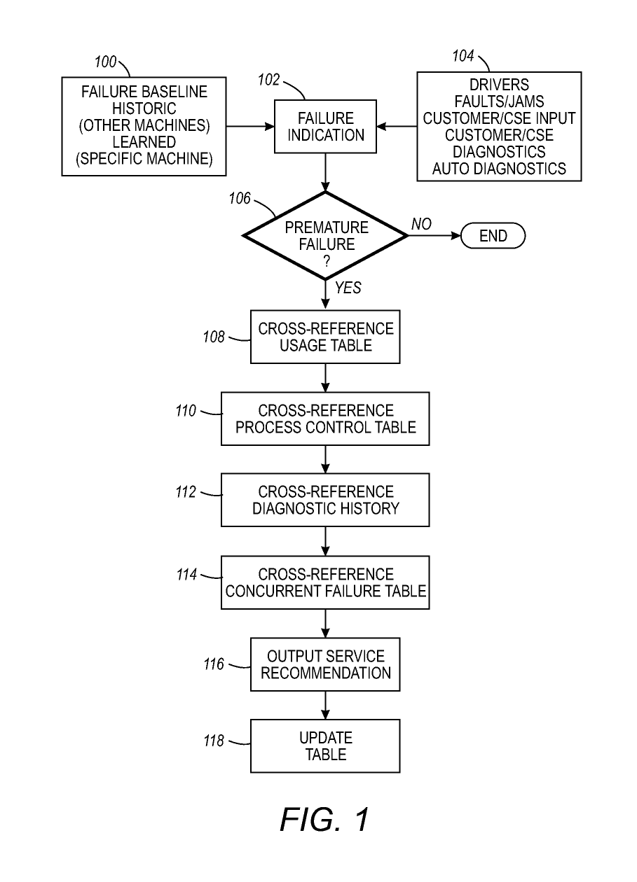

As shown in flowchart form in FIG. 1, one exemplary method herein receives from an apparatus or device, an identification of a failed part within the apparatus in item 102. For example, a printing apparatus, such as a printer or copier could self-diagnose that it has a failed or worn out drum or belt. This identification can be received by the device itself (e.g., by the printer or copier) or by a computing device (such as a special purpose or general purpose computer) that is in communication with the self-diagnosing apparatus.

More specifically, as shown in item 100, the failure indication 102 can be based upon various failure baselines. Some baselines can be historic and are based on the failures of other similar (or identical) machines. Additional baselines can be learned baselines that are based on the specific machine in question. As indicated by item 104, the drivers for the failure indication can include faults or jams within the specific machine, customer or service engineer input and diagnostics as well as auto diagnostics.

The method then determines, in item 106, if the failed part failed prematurely by evaluating whether the failed part failed within one of a plurality of predetermined threshold usage ranges. The predetermined threshold ranges are less than a predicted full useful life of the failed part. Therefore, if the part failed within one of the usage ranges it would be considered to have failed before its predicted full useful life and to have failed prematurely in item 106.

To determine whether the failed part failed prematurely in item 106, the embodiments herein extract usage data from a usage meter within the apparatus and/or the failed part, and compare the usage data to the predetermined threshold usage ranges to identify which of the predetermined threshold usage ranges the failed part failed within.

If the failed part failed prematurely, in item 108 the method cross-references a service recommendation table to identify a service recommendation based on which of the predetermined threshold usage ranges the failed part failed within.

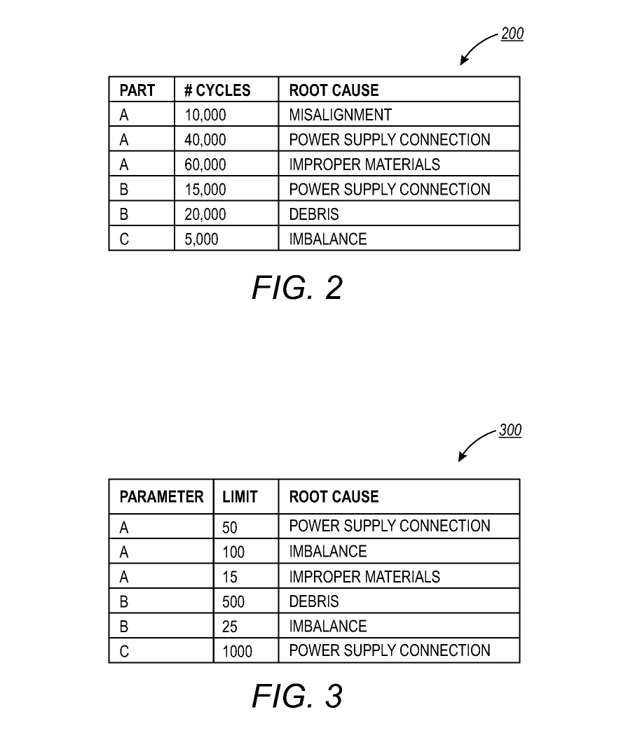

An exemplary service recommendation table 200 based on usage (usage table) is shown in FIG. 2. The usage table provides different service recommendations for different predetermined threshold usage ranges of different parts. The service recommendations are often recommendations that adjust or replace items other than the failed part itself.

For example, as shown in FIG. 2, if part A fails before it reaches 10,000 cycles, this failure is often caused by a misalignment within the apparatus. Thus, the root cause of the failure is not a defect within part A, but instead the root cause has been historically determined by previous service engineers to be an alignment issue. Simply replacing part A without correcting the misalignment would result in part A failing prematurely again.

If part A fails between 10,000 cycles and 40,000 cycles, this indicates some form of improper power supply connection. Similarly, if part A fails between 40,000 and 60,000 cycles this indicates that improper materials have been used within the apparatus. If part A fails above 60,000 cycles, it is not considered a premature failure.

Similarly, different parts (B and C) have different ranges of premature failure and the usage table 200 shown in FIG. 2. Each of the different ranges of premature failure indicates a specific probable root cause for the failure which is independent of the part itself.

Thus, the service recommendations address the root cause that may have caused the part to fail prematurely. Further, the threshold ranges are different for different parts of the apparatus because different root causes are identified by unique usage ranges. In other words, failure within a first usage range would indicate that one set of circumstances could be the root cause of the premature failure of the part; while failure within a second usage range would indicate that a different set of circumstances could be the root cause of the premature failure of the part. Each of these different usage ranges is unique to each different root cause.

Each of the tables described herein are established by observing historical data. If a specific root cause consistently occurs within a specific range (number of cycles) and it has been established that there is a correlation between the root cause and the specific range for a class of machine, it is included within one of the tables mentioned herein. Thus, each of the tables is based on historically proven root causes and previously established ranges (e.g., number of cycles).

In item 110, the embodiments herein can cross-reference a process control table. An exemplary process control table 300 is illustrated in FIG. 3. The process control table maintains various limits for various parameters and, if a parameter is outside of one of the acceptable ranges, this can be detected by comparing the measured parameter to the process control table 300. Further, different parameter limits can be established for an individual parameter to indicate different root causes.

Thus, embodiments herein determine if a parameter associated with the failed part is within one of a plurality of predetermined parameter value ranges. Then the method cross-references the process control table to identify the service recommendation based on which of the parameter value ranges the failed part failed within, using the computing device.

For example, if the value for parameter A exceeds 50 (but is less than 100) when the part failed, the root cause has historically been shown to be a power supply connection. However, if the value of parameter A exceeds 100 when the part fails, this indicates a different root cause (some form of the imbalance within the machine). Similarly, multiple limits are illustrated for parameter B and single limits are illustrated for parameters C and D. Each value that exceeds the limit includes a historically based root cause. Again, these root causes are established according to historical parameter limits and historically established root causes for such parameter limits.

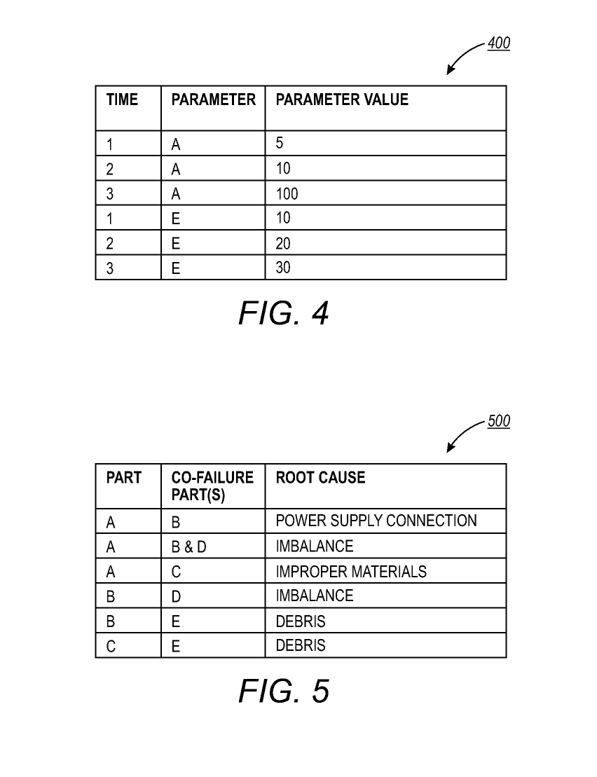

In item 112, the embodiments herein can cross reference the diagnostic history table, such as the one illustrated in FIG. 4. More specifically, the diagnostic history table 400 illustrated in FIG. 4 illustrates different parameter values for different parameters over consecutive, equal time periods. As shown in item 400, parameter A gradually increases in time periods 1 and 2, but then dramatically increases in time period 3. To the contrary, parameter E gradually increases in time periods 1-3. Whenever a parameter exceeds the parameter limit during a part failure, the embodiments herein can utilize the diagnostic history table 400 to determine whether the parameter gradually increased before exceeding the limit or whether there was a sharp change in the parameter that caused it to exceed the limit. This could refined the conclusion of root cause found in the process control table 300 in FIG. 3, and may sometimes indicate a different root cause.

Thus, the embodiments herein determine whether a parameter associated with the failed part changed relatively gradually or changed relatively abruptly. Then the methods herein alter the service recommendation based on whether the parameter changed gradually or changed abruptly.

In item 114, the method also checks to determine if the part in question failed concurrently with another corresponding part by referring to a concurrence failure table, such as the one illustrated in FIG. 5. In some instances, the concurrent failure of two or more parts can indicate a root cause that is related to both failures. For example, a service recommendation table 500 based on concurrent part failure (concurrent failure table) is shown in FIG. 5. The concurrent failure table provides different service recommendations for different instances of concurrent part failure. For example, if parts A failed concurrently with parts B and D, this would indicate an imbalance issue within the apparatus, while a failure of just parts A and B would indicate a power supply connection issue. As shown, the service recommendations are often recommendations that adjust or replace items other than the failed part itself.

In item 116, the method outputs instructions to service the failed part and the service recommendations to a service engineer. This not only tells the service engineer which part needs to be replaced, but also provides the service engineer with an instruction to replace or adjust a different part or element that was the root cause of the premature failure of the part.

In item 118, the embodiments herein maintain and constantly update the usage table 200 based on historical and new incoming service records of apparatuses similar to the apparatus. In other words, as new root causes are discovered over time, the usage table 200 can be continually updated.

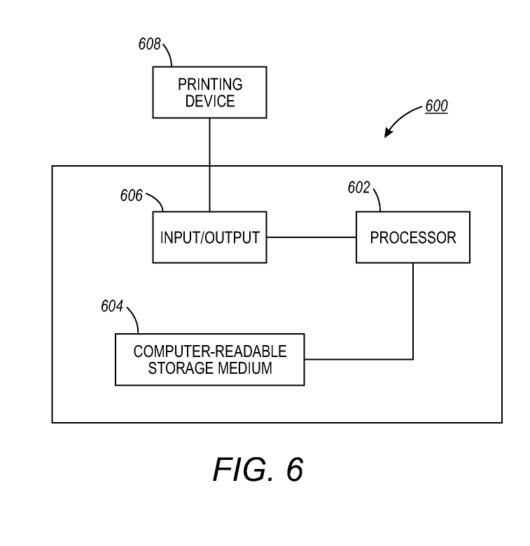

As shown in FIG. 6, also disclosed herein are device embodiments, such as a general purpose or special purpose computerized apparatus 600 that includes an input/output device 606 operatively connected to a processor 602. The input/output device 606 receives, from a second apparatus 608, such as a printing device (separate from the apparatus 600) an identification of the failed part within the second apparatus 608. The apparatus 600 could be included within, or could be separate from the second apparatus 608.

A computer-readable storage medium 604 is also operatively connected to the processor 602. The computer-readable storage medium 604 stores programming instructions executable by the processor 602, stores the plurality of predetermined threshold usage ranges, and stores the usage table 200. The programming instructions are executed by the processor 602 to perform the various methods described herein.

The processor 602 determines if the failed part failed prematurely by evaluating whether the failed part failed within one of the plurality of predetermined threshold usage ranges. The processor 602 determines whether the failed part failed prematurely by extracting usage data from a usage meter within the second apparatus 608 and/or the failed part, and comparing the usage data to the predetermined threshold usage ranges to identify which of the predetermined threshold usage ranges the failed part failed within. The processor 602 also maintains and updates the usage table 200 based on historical and new service records of second apparatuses similar to the second apparatus 608.

If the failed part failed prematurely, the processor 602 cross-references the usage table 200 to identify the service recommendation based on which of the predetermined threshold usage ranges the failed part failed within. Then, the input/output device 606 outputs instructions to service the failed part and the service recommendation.

Understanding where within the overall life distribution the parts are failing provides better identification of the root cause of the failure and provides the most appropriate diagnostic and repair information to the customer or the customer service engineer (CSE).

The root causes of premature failures are typically captured in repair records or field service bulletins; however, conventional systems rely on the service engineer remembering and recognizing the triggering condition(s) for various parts. Because the embodiments herein automatically notify the service engineer of potential root causes for early parts failures, the embodiments herein reduce both unscheduled maintenance requests and parts costs.

Therefore, the embodiments herein provide improved diagnostic capability, and an accelerated method/system for delivering needed information to the service engineer for specific circumstances including quality issues, incorrect maintenance actions, or recommend best practices.

Many computerized devices are discussed above. Computerized devices that include chip-based central processing units (CPU's), input/output devices (including graphic user interfaces (GUI), memories, comparators, processors, etc. are well-known and readily available devices produced by manufacturers such as Dell Computers, Round Rock Tex., USA and Apple Computer Co., Cupertino Calif., USA. Such computerized devices commonly include input/output devices, power supplies, processors, electronic storage memories, wiring, etc., the details of which are omitted herefrom to allow the reader to focus on the salient aspects of the embodiments described herein. Similarly, scanners and other similar peripheral equipment are available from Xerox Corporation, Norwalk, Conn., USA and the details of such devices are not discussed herein for purposes of brevity and reader focus.

The terms printer or printing device as used herein encompasses any apparatus, such as a digital copier, bookmaking machine, facsimile machine, multi-function machine, etc., which performs a print outputting function for any purpose. The details of printers, printing engines, etc., are well-known by those ordinarily skilled in the art and are discussed in, for example, U.S. Pat. No. 6,032,004, the complete disclosure of which is fully incorporated herein by reference. The embodiments herein can encompass embodiments that print in color, monochrome, or handle color or monochrome image data. All foregoing embodiments are specifically applicable to electrostatographic and/or xerographic machines and/or processes.

It will be appreciated that the above-disclosed and other features and functions, or alternatives thereof, may be desirably combined into many other different systems or applications. Various presently unforeseen or unanticipated alternatives, modifications, variations, or improvements therein may be subsequently made by those skilled in the art which are also intended to be encompassed by the following claims. The claims can encompass embodiments in hardware, software, and/or a combination thereof. Unless specifically defined in a specific claim itself, steps or components of the embodiments herein cannot be implied or imported from any above example as limitations to any particular order, number, position, size, shape, angle, color, or material.

What is claimed is:

1. A method comprising:
receiving from an apparatus, an identification of a failed part within said apparatus, by a computing device in communication with said apparatus;
determining, by said computing device, if said failed part failed prematurely by evaluating whether said failed part failed within one of a plurality of predetermined threshold usage ranges;
if said failed part failed prematurely, cross referencing a service recommendation table to identify a service recommendation based on which of said predetermined threshold usage ranges said failed part failed within, using said computing device; and
outputting, from said computing device, instructions to service said failed part and said service recommendation.

2. The method according to claim 1, said plurality of predetermined threshold ranges comprising less than a predicted full useful life of said failed part.

3. The method according to claim 1, said plurality of predetermined threshold ranges comprising different for different parts of said apparatus.

4. The method according to claim 1, further comprising maintaining said service recommendation table based on historical service records of apparatuses similar to said apparatus.

5. The method according to claim 1, said determining of whether said failed part failed prematurely comprising using said computing device to:
extract usage data from a usage meter within at least one of said apparatus and said failed part; and
compare said usage data to said predetermined threshold usage ranges to identify which of said predetermined threshold usage ranges said failed part failed within.

6. A method comprising:
receiving from an apparatus, an identification of a failed part within said apparatus, by a computing device in communication with said apparatus;
determining, by said computing device, if said failed part failed prematurely by evaluating whether said failed part failed within one of a plurality of predetermined threshold usage ranges;
if said failed part failed prematurely, cross referencing a service recommendation table to identify a service recommendation based on which of said predetermined threshold usage ranges said failed part failed within, using said computing device, said service recommendation table providing different service recommendations for different predetermined threshold usage ranges of different parts, and said service recommendations comprising adjusting or replacing items other than said failed part; and
outputting, from said computing device, instructions to service said failed part and said service recommendation.

7. The method according to claim 6, said plurality of predetermined threshold ranges comprising less than a predicted full useful life of said failed part.

8. The method according to claim 6, further comprising:
determining, by said computing device, if a parameter associated with said failed part is within one of a plurality of predetermined parameter value ranges; and
cross-referencing a process control table to identify said service recommendation based on which of said parameter value ranges said failed part failed within, using said computing device.

9. The method according to claim 8, further comprising:
determining whether a parameter associated with said failed part changed relatively gradually or changed relatively abruptly; and
altering said service recommendation based on whether said parameter changed gradually or changed abruptly.

10. The method according to claim 6, further comprising:
determining if said failed part failed concurrently with another corresponding part by referring to a concurrence failure table; and
altering said service recommendation based on whether said failed part failed concurrently with another corresponding part.

11. A method comprising:
receiving from an printing apparatus, an identification of a failed printing part within said printing apparatus, by a computing device in communication with said printing apparatus;
determining, by said computing device, if said failed printing part failed prematurely by evaluating whether said failed printing part failed within one of a plurality of predetermined threshold usage ranges;
if said failed printing part failed prematurely, cross referencing a service recommendation table to identify a service recommendation based on which of said predetermined threshold usage ranges said failed printing part failed within, using said computing device, said service recommendation table providing different service recommendations for different predetermined threshold usage ranges of different printing parts, and said service recommendations comprising adjusting or replacing items other than said failed printing part; and
outputting, from said computing device, instructions to service said failed printing part and said service recommendation.

12. The method according to claim 11, said plurality of predetermined threshold ranges comprising less than a predicted full useful life of said failed printing part.

13. The method according to claim 11, further comprising:
determining, by said computing device, if a parameter associated with said failed part is within one of a plurality of predetermined parameter value ranges; and
cross-referencing a process control table to identify said service recommendation based on which of said parameter value ranges said failed part failed within, using said computing device.

14. The method according to claim 13, further comprising:
determining whether a parameter associated with said failed part changed relatively gradually or changed relatively abruptly; and
altering said service recommendation based on whether said parameter changed gradually or changed abruptly.

15. The method according to claim 11, further comprising:
determining if said failed part failed concurrently with another corresponding part by referring to a concurrence failure table; and
altering said service recommendation based on whether said failed part failed concurrently with another corresponding part.

16. An apparatus comprising:
a processor;
an input/output device operatively connected to said processor, said input/output device receiving, from a second apparatus separate from said apparatus, an identification of a failed part within said second apparatus; and
a computer-readable storage medium operatively connected to said processor, said computer-readable storage medium storing programming instructions executable by said processor, storing a plurality of predetermined threshold usage ranges, and storing a service recommendation table,
said processor determining if said failed part failed prematurely by evaluating whether said failed part failed within one of said plurality of predetermined threshold usage ranges;
if said failed part failed prematurely, said processor cross-references said service recommendation table to identify a service recommendation based on which of said predetermined threshold usage ranges said failed part failed within, and
said input/output device outputting instructions to service said failed part and said service recommendation.

17. The apparatus according to claim 16, said plurality of predetermined threshold ranges comprising less than a predicted full useful life of said failed part.

18. The apparatus according to claim 16, said plurality of predetermined threshold ranges comprising different for different parts of said second apparatus.

19. The apparatus according to claim 16, said processor maintaining said service recommendation table based on historical service records of second apparatuses similar to said second apparatus.

20. The apparatus according to claim 16, said processor determining whether said failed part failed prematurely by:
extracting usage data from a usage meter within at least one of said second apparatus and said failed part; and
comparing said usage data to said predetermined threshold usage ranges to identify which of said predetermined threshold usage ranges said failed part failed within.
